(19) United States
(12) Patent Application Publication
(10) Pub. No.: US 2021/0311729 A1
(43) Pub. Date: Oct. 7, 2021

(54) CODE REVIEW SYSTEM

(71) Applicant: SAP SE, Walldorf (DE)

(72) Inventors: Divyank Gupta, Kota (IN); Shaswat Deep, Anuppur (IN)

(21) Appl. No.: 16/876,302

(22) Filed: May 18, 2020

(30) Foreign Application Priority Data
Apr. 3, 2020 (IN) 202011014859

(51) Int. Cl. G06F 8/73; G06N 3/08; G06N 3/04

(52) U.S. Cl. CPC G06F 8/73; G06N 3/04; G06N 3/08

(57) ABSTRACT

Systems and methods provide acquisition of a plurality of code artifacts and one or more code review comments associated with each code artifact, generation of a set of code features based on each of the plurality of code artifacts, input of each set of code features to a neural network to generate code review comments respectively associated with each of the plurality of code artifacts, determination of a loss by comparing each generated code review comment respectively associated with one of plurality of code artifacts with the one or more review comments associated with the one of plurality of code artifacts, and modification of the neural network based on the loss.

### CROSS-REFERENCE TO RELATED APPLICATIONS

The present application claims priority to Indian Provisional Application No. 202011014859, filed Apr. 3, 2020, for all purposes.

### BACKGROUND

The development of software applications is typically governed by a formal development lifecycle. For example, a software developer may develop a code artifact and test the code artifact independently. Once the code artifact is complete, the developer submits the code artifact to a centralized repository for code review. Code review may comprise checking code quality (e.g., with respect to industry and organizational standards) and identifying functional defects, performance issues and/or security issues.

During code review, a reviewer manually reviews a code artifact and provides code review comments. The code review comments may identify bugs, alternative approaches, and further optimizations, for example. Code review can be repetitive and tedious. Each new or changed code artifact must be reviewed, and a code reviewer executes the same reviewing steps repeatedly each time a new code artifact is submitted for review. Code review can therefore be mentally demanding, error-prone, and slow.

Some automated static checks are available to provide review of basic coding errors. These static checks are limited in their capabilities and cannot analyze performance and code optimization issues. Accordingly, systems are desired to improve the efficiency and efficacy of code review.

### BRIEF DESCRIPTION OF THE DRAWINGS

FIG. 1 illustrates an architecture to review code artifacts using a trained network according to some embodiments.

FIG. 2 illustrates an architecture to train an artificial neural network to generate code review comments based on code artifacts according to some embodiments.

FIG. 3 is flow diagram of a process to train an artificial neural network to generate code review comments based on code artifacts according to some embodiments.

FIG. 4 illustrates a system to generate training data according to some embodiments.

FIG. 5 illustrates a code development architecture according to some embodiments.

FIG. 6 is a block diagram of a computing system to perform training of an artificial neural network to generate code review comments based on code artifacts according to some embodiments.

FIG. 7 is a block diagram of a computing system deploying an artificial neural network to generate review comments based on code artifacts according to some embodiments.

### DETAILED DESCRIPTION

The following description is provided to enable any person in the art to make and use the described embodiments. Various modifications, however, will remain readily-apparent to those in the art.

Some embodiments utilize a trained artificial neural network to facilitate effective and efficient code review. Such a network may be trained based on features extracted from prior code artifacts and associated review comments. A network according to some embodiments may be used to generate review comments for an input code artifact, and may be incorporated into existing review workflow and/or development environments. Embodiments may therefore increase the quality of and reduce the time and resources required for code review.

FIG. 1 is a block diagram of system 100 according to some embodiments. System 100 implements code review using a trained network according to some embodiments. Embodiments are not limited to system 100.

According to FIG. 1, developer 110 submits code artifact 120 to code feature extractor 130. Developer 110 may generate code artifact in any manner that is or becomes known. In one typical example, developer 110 operates an integrated development environment (IDE) (not shown) to create code artifact 120. Code artifact 120 may conform to any programming language and/or application structure that is or becomes known. Code artifact 120 may comprise a module, library, application, interface or any other suitable entity. Code artifact 120 may be executable (post- or pre-compilation) to cause a computing device to perform one or more functions.

Code feature extractor 130 extracts features based on code artifact 120. The features may include but are not limited to structural features of code artifact 120 (e.g., for loops, data structures, functions including>X lines of code, functions including>Y parameters), features related to internal programming guidelines (e.g., lines per comment), security best practices set by internal and external developer communities, cyclometric complexity of code and other features. Code feature extractor 130 may comprise program code developed to parse code artifacts and output corresponding features.

The extracted features are input to code review classifier 140. According to some embodiments, code review classifier 140 comprises an artificial neural network which has been previously trained as described below to generate code review comments 150 based on input features extracted from a code artifact. Code review classifier 140 may therefore comprise a classification network, such as but not limited to a random forest network. Code review comments 150 may comprise various categories, such as but not limited to performance, logical error, project standards. In some embodiments, code review classifier 140 may assign a probability to each category of code review comment which classifier 140 is configured to classify.

The illustrated elements of system 100 may be implemented using any suitable combination of computing hardware and/or software that is or becomes known. For example, each unit, component or other functional system described herein may be implemented by one or more computing devices (e.g., computer servers), storage devices (e.g., hard or solid-state disk drives), and other hardware as is known in the art. An element of system 100 may be implemented in processor-executable program code executed by one or more computing devices. In some embodiments, two or more elements of system 100 are implemented by a single computing device. These elements may be located remote from one another and may be elements of one or more cloud computing platforms, including but not limited to a Software-as-a-Service, a Platform-as-a-Service, and an Infrastructure-as-a-Service platform.

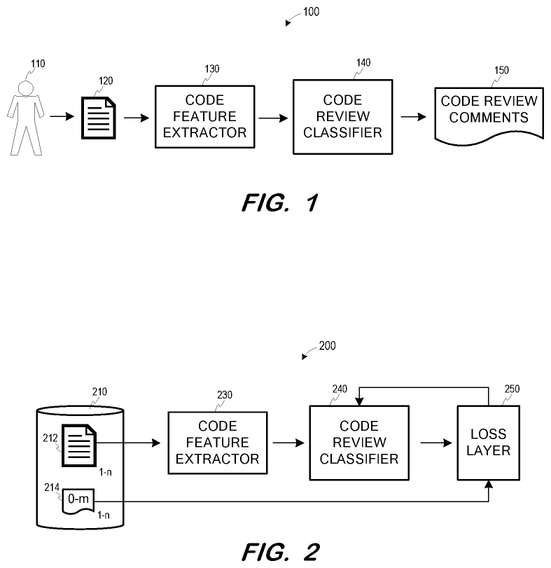

FIG. 2 illustrates system 200 for training a code review classifier according to some embodiments. Generally, code review classifier 240 may be trained based on training data 210 to receive an input code artifact and output classified code review comments based thereon.

Code review classifier 240 may comprise a network of neurons which receive input, change internal state according to that input, and produce output depending on the input and the internal state. The output of certain neurons is connected to the input of other neurons to form a directed and weighted graph. The weights as well as the functions that compute the internal state can be modified by a training process based on ground truth data as is known in the art. Code review classifier 240 may comprise any one or more types of artificial neural network that are or become known, including but not limited to convolutional neural networks, recurrent neural networks, long short-term memory networks, deep reservoir computing and deep echo state networks, deep belief networks, and deep stacking networks.

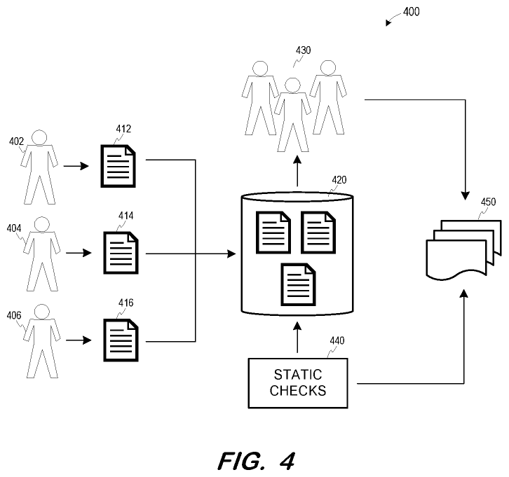

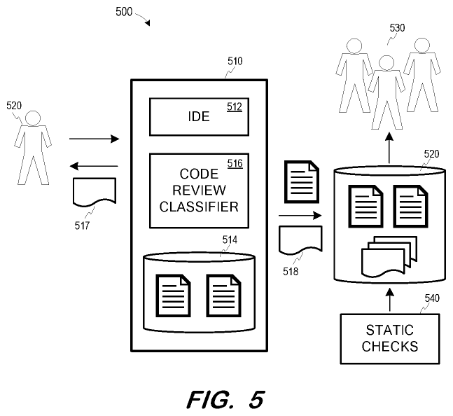

Training data 210 comprises n code artifacts 212 and 0-m code review comments 214 corresponding to each of the n code artifacts 212. The 0-m code review comments 214 associated with each of n code artifacts 212 may have been generated by a conventional code review process as will be described below with respect to FIG. 4. In the parlance of neural network training, each of 0-m code review comments 214 is considered ground truth data corresponding to a respective one of n code artifacts 212.

During training, code feature extractor 230 extracts features from each of n code artifacts 212 and inputs those features (e.g., sequentially by code artifact) into code review classifier 240. Based on its initial configuration and design, code review classifier 240 outputs predicted code review comments corresponding to each code artifact 212. Loss layer component 250 determines a loss by comparing the predicted code review comments generated based on a code artifact 212 with the actual code review comments 214 associated with the code artifact 212 within training data 210. The loss is determined for each code artifact 212 in order to determine a total loss. The loss may comprise an L1 loss, and L2 loss, or any other suitable measure of total loss known in the art.

The total loss is back-propagated from loss layer component 250 to code review classifier 240. As is known in the art, the internal weights of code review classifier 240 are modified in response to the total loss. The foregoing process repeats until it is determined that the total loss has reached an acceptable level or training otherwise terminates.

System 200 may comprise any system or systems for training an artificial neural network that are or become known. For example, training system 200 may employ supervised learning, unsupervised learning and/or reinforcement learning used as a function approximator as is known in the context of deep neural networks. Generative adversarial networks may be used including a generative and a discriminative network as is known.

According to some embodiments, trained code review classifier 240 implements a function. The function may be characterized as a set of parameter values associated with each node of the network. In one example, the function is represented by parameter values of kernels of a fully convolutional network. The function (e.g., embodied in parameter values of trained convolutional kernels) may be deployed as is known in the art to another system such as system 100 of FIG. 1.

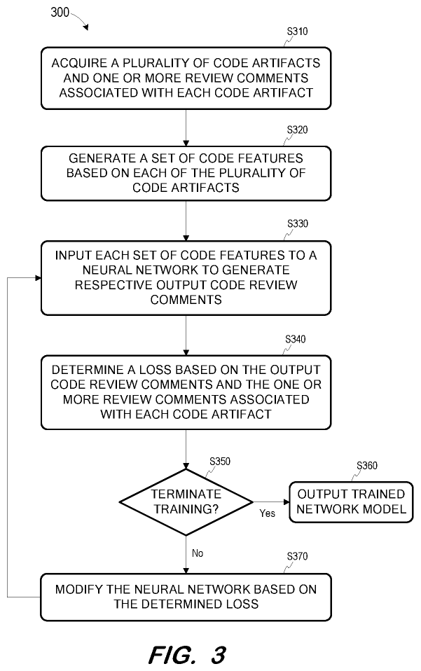

FIG. 3 is a flow diagram of process 300 to describe the training depicted in FIG. 2 according to some embodiments. Process 300 and the other processes described herein may be performed using any suitable combination of hardware and software. Software program code embodying these processes may be stored by any non-transitory tangible medium, including a fixed disk, a volatile or non-volatile random access memory, a DVD, a Flash drive, or a magnetic tape. Embodiments are not limited to the examples described below.

Initially, S310 comprises acquisition of code artifacts and one or more review comments associated with each code artifact. As mentioned above, the code artifacts and associated comments may be acquired from a conventional code review process. FIG. 4 illustrates such a conventional code review process which may implement S310, to which embodiments are not limited.

System 400 may comprise a conventional development architecture. Developers 402, 406 and 408 develop and submit respective code artifacts 412, 414 and 416 using integrated development environments. The environments may be local to each developer or managed by a common application server. In either case, code artifacts 412, 414 and 416 are submitted (or committed) to central repository 420 as is known in the art.

Central repository 420 may be on-premise or cloud-based, and may be managed by a single application provider to ensure compliance with internal and general coding standards and policies. Compliance is assured in the present example by requiring review of artifact stored in repository 420 by one or more code reviewers 430 and by one or more static checks 440. As is known in the art, static checks 440 may comprise general and/or artifact-specific checks (e.g., Jenkins Jobs).

Reviewers 430 generate code review comments 450 for each reviewed artifact in repository 420. Similarly, static checks 440 may generate code review comments 450 for each artifact reviewed thereby. The type of review comments 450 generated by reviewers 450 may differ from those generated by static checks 440. Review comments 450 may comprise comments indicating real or potential errors, coding guidelines to which a code artifact fails to conform, suggested optimizations, etc. Review comments 540 may also be positive, such as an indication of conforming code, a well-written routine, etc.

S310 may therefore comprise acquisition of code review comments 450 and of the specifics artifacts of repository 420 based on which these comments 450 were generated. Next, at S320, a set of code features is generated based on each of the plurality of code artifacts acquired at S310. Generation of the code features at S320 may proceed programmatically by executing a software application designed for this purpose. According to some embodiments, the features are generated by a separate trained neural network.

Each set of code features is input to a neural network at S330 to generate respective output code review comments. As mentioned above, the neural network may comprise a classification network and the generated code review comments for a given input code artifact may comprise a probability assigned to each of several possible code review comments.

A loss is determined at S340 based on the output code review comments and the one or more review comments associated with each code artifact. More specifically, the loss may be determined by comparing, for each code artifact, the code review comments generated based on the code artifact with the actual code review comments associated with the code artifact within the data acquired at S310.

At S350, it is determined whether to terminate training. The determination may be based on whether the loss has reached an acceptable level, based on evaluation of the performance of the currently-modified network on a set of test input data, based on an elapsed amount of training time or number of training epochs, and or on other criteria. Flow proceeds to S360 if it is determined at S350 to terminate training. The trained network model is output at S360. The trained network model may consist of a set of hyperparameters defining the network structure, parameter values or kernels representing trained values, and/or any other data sets needed to reproduce the function implemented by the trained neural network on its inputs.

If the determination at S350 is negative, the neural network is modified at S370 based on the loss. The modification may proceed in any suitable manner known in the art. Flow then returns to S330 and repeats as described above. In this regard, each iteration of S330 through S350 is considered a single training epoch.

FIG. 5 illustrates deployment of a trained neural network according to some embodiments. Embodiments are not limited to the FIG. 5 deployment. Deployment of a trained neural network generally comprises implementing the learned algorithm embodied by the trained network in a computing device as is known in the art. Such implementation may include copying of the hyperparameters of the trained network and the learned parameter values/kernels to the computing device.

System 500 of FIG. 5 is a software development environment. Developer 520 accesses IDE 512 executed by application server 510, which may comprise an on-premise or cloud-based server, in order to generate code artifacts. The code artifacts under development may be stored in storage 514.

In one example, application server 510 includes program code implementing code review classifier 516 trained as described above. Developer 520 may instruct IDE 512 to input a code artifact of storage 514 to classifier 516, resulting in code review comments 517. Developer 520 may therefore modify the code artifact based on code review comments 517 before committing the code artifact to a repository.

In another example, developer 520 instructs IDE 512 to commit a code artifact and the code artifact is input to classifier 516. Classifier 516 generates code review comments 518 based on the code artifact and both comments 518 and the code artifact are stored in repository 520. Then, as described above, code artifacts stored in repository 520 are reviewed by reviewers 530 and static checks 540. However, unlike the system of FIG. 4, these reviews are assisted by corresponding code review comments generated by classifier 516 and stored in conjunction with the code artifacts in repository 520.

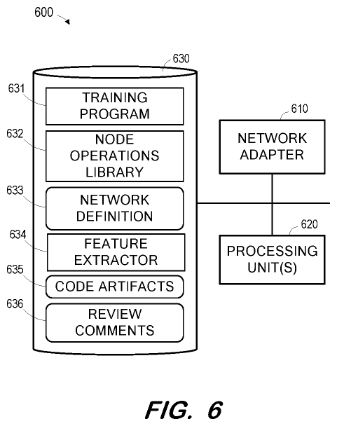

FIG. 6 illustrates computing system 600 according to some embodiments. System 600 may comprise a computing system to facilitate the design and training of a neural network as is known in the art. Computing system 600 may comprise a standalone system, or one or more elements of computing system 600 may be located in the cloud.

System 600 includes network adapter 610 to communicate with external devices via a network connection. Processing unit(s) 620 may comprise one or more processors, processor cores, or other processing units to execute processor-executable process steps. In this regard, storage system 630, which may comprise one or more memory devices (e.g., a hard disk drive, a solid-state drive), stores processor-executable process steps of training program 631 which may be executed by processing unit(s) 620 to train a network as described herein.

Training program 631 may utilize node operations library 632, which includes code to execute various operations associated with node operations as defined in node operations library 632. According to some embodiments, computing system 600 provides interfaces and development software (not shown) to enable development of training program 631 and generation of network definition 633. Storage system 630 also includes program code of feature extractor 634, code artifacts 635 and associated review comments 636, which may be used by training program 631 as described above to train a network defined by network definition 633.

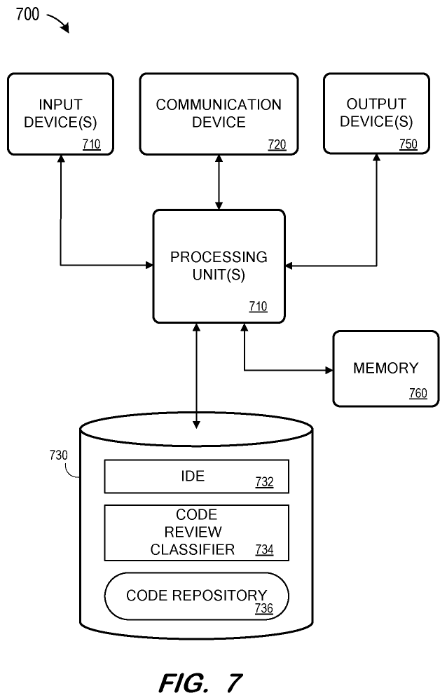

FIG. 7 is a block diagram of apparatus 700 according to some embodiments. Apparatus 700 may comprise a general-purpose computing apparatus and may execute program code to perform any of the functions described herein. Apparatus 700 may comprise an implementation of server 510 in some embodiments. Apparatus 700 may include other unshown elements according to some embodiments.

Apparatus 700 includes processing unit(s) 710 operatively coupled to communication device 720, data storage device 730, one or more input devices 740, one or more output devices 750 and memory 760. Communication device 720 may comprise a network card for communication with external networks. Input device(s) 740 may comprise, for example, a keyboard, a keypad, a mouse or other pointing device, a microphone, knob or a switch, an infra-red (IR) port, a docking station, and/or a touch screen. Input device(s) 740 may be used, for example, to enter information into apparatus 700. Output device(s) 750 may comprise, for example, a display (e.g., a display screen), a speaker, and/or a printer.

Data storage device 730 may comprise any appropriate persistent storage device, including combinations of magnetic storage devices (e.g., magnetic tape, hard disk drives and flash memory), optical storage devices, Read Only Memory (ROM) devices, etc., while memory 760 may comprise Random Access Memory (RAM), Storage Class Memory (SCM) or any other fast-access memory.

IDE 732 may comprise program code executable by processing unit(s) 710 to provide interfaces and functionality to facilitate application development. Code review classifier 734 may comprise program code to implement a trained code review classifier as described above. Embodiments are not limited to execution of these processes by a single apparatus.

Code repository 736 may include code artifacts developed using IDE 732, and which may be input to code review classifier 734 as described above to generate corresponding code review comments. Data storage device 730 may also store data and other program code for providing additional functionality and/or which are necessary for operation of apparatus 700, such as device drivers, operating system files, etc.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation of a system according to some embodiments may include a processor to execute program code such that the computing device operates as described herein.

All systems and processes discussed herein may be embodied in program code stored on one or more non-transitory computer-readable media. Such media may include, for example, a hard disk, a DVD-ROM, a Flash drive, magnetic tape, and solid-state Random Access Memory (RAM) or Read Only Memory (ROM) storage units. Embodiments are therefore not limited to any specific combination of hardware and software.

Embodiments described herein are solely for the purpose of illustration. Those in the art will recognize other embodiments may be practiced with modifications and alterations to that described above.

What is claimed is:

1. A system comprising:
a storage device storing a plurality of sets of training data and a plurality of sets of ground truth data corresponding to respective ones of the plurality of sets of training data; and
a processor to execute processor-executable process steps stored on the storage device to cause the system to:
acquire a plurality of code artifacts and one or more code review comments associated with each code artifact;
generate a set of code features based on each of the plurality of code artifacts;
input each set of code features to a neural network to generate code review comments respectively associated with each of the plurality of code artifacts;
determine a loss by comparing each generated code review comment respectively associated with one of plurality of code artifacts with the one or more review comments associated with the one of plurality of code artifacts; and
modify the neural network based on the loss.

2. A system according to claim 1, wherein the neural network is a classifier.

3. A system according to claim 1, wherein acquisition of the plurality of code artifacts and one or more code review comments associated with each code artifact comprises:
performance of a manual review and a static check on each of the plurality of code artifacts to generate the one or more code review comments associated with each code artifact.

4. A system according to claim 1, the processor to execute processor-executable process steps stored on the storage device to cause the system to output trained kernels of the neural network to a second system, wherein the second system is to:
acquire a code artifact;
determine code features based on the code artifact;
input the code features to a second neural network comprising the trained kernels;
receive one or more code review comments output from the second neural network based on the code artifact; and
store the output one or more code review comments.

5. A system according to claim 4, wherein the code artifact is acquired from a developer, and wherein the stored one or more code review comments are transmitted to the developer.

6. A system according to claim 4, wherein performance of a manual review and a static check on the code artifact is based on the stored one or more code review comments.

7. A computer-implemented method comprising:
acquiring a code artifact;
determining code features of the code artifact;
inputting the code features to a neural network trained based on a set of code features determined based on respective ones of a plurality of code artifacts, and on one or more code review comments associated with each of the plurality of code artifacts;
receiving one or more code review comments output from the neural network based on the input code artifact; and
storing the output one or more code review comments.

8. A method according to claim 7, wherein the code artifact is acquired from a developer, and further comprising transmitting the stored one or more code review comments to the developer.

9. A method according to claim 7, further comprising:
performing a manual review based on the stored one or more code review comments; and
performing a static check on the code artifact based on the stored one or more code review comments.

10. A non-transitory medium storing processor-executable process steps, the process steps executable to cause a system to:
acquire a plurality of code artifacts and one or more code review comments associated with each code artifact;
generate a set of code features based on each of the plurality of code artifacts;
input each set of code features to a neural network to generate code review comments respectively associated with each of the plurality of code artifacts;
determine a loss based on each generated code review comment and the one or more review comments associated with each of plurality of code artifacts; and
modify the neural network based on the loss.

11. A medium according to claim 10, wherein the neural network is a classifier.

12. A medium according to claim 10, wherein plurality of code artifacts and one or more code review comments associated with each code artifact were generated by performance of a manual review and a static check on each of the plurality of code artifacts.

13. A medium according to claim 10, the process steps executable to cause a system to output trained kernels of the neural network to a second system, wherein the second system is to:
acquire a code artifact;
determine code features based on the code artifact;
input the code features to a second neural network comprising the trained kernels;
receive one or more code review comments output from the second neural network based on the code artifact; and
store the output one or more code review comments.

16. A medium according to claim 13, wherein the code artifact is acquired from a developer, and wherein the stored one or more code review comments are transmitted to the developer.

17. A medium according to claim 13, wherein a manual review and a static check are performed on the code artifact based on the stored one or more code review comments.
